(19) United States
(12) Patent Application Publication
(10) Pub. No.: US 2020/0061892 A1
(43) Pub. Date: Feb. 27, 2020

(54) HOT RUNNER DEVICE

(71) Applicant: TOYOTA JIDOSHA KABUSHIKI KAISHA, Toyota-shi (JP)

(72) Inventor: Hideaki ASUKA, Toyota-shi (JP)

(73) Assignee: TOYOTA JIDOSHA KABUSHIKI KAISHA, Toyota-shi (JP)

(21) Appl. No.: 16/508,523

(22) Filed: Jul. 11, 2019

(30) Foreign Application Priority Data
Aug. 21, 2018 (JP) 2018-154715

(51) Int. Cl. B29C 45/27; B29C 45/28

(52) U.S. Cl. CPC B29C 45/2727; B29C 45/281; B29C 45/2708

(57) ABSTRACT

A hot runner device includes a fixed die, a hot runner block, a valve gate, and a valve pin. The hot runner block includes a first block including a first resin passage, a second block including a second resin passage communicating with the valve gate and a hot runner pipe through which the first resin passage communicates with the second resin passage. The hot runner pipe is disposed such that a first end of the hot runner pipe is fixed to one of the first and second blocks, and a second end of the hot runner pipe is distanced from the other one of the first and second blocks by a predetermined distance in a pipe axial direction during cold time. The predetermined distance is set to be smaller than an expansion amount of the hot runner pipe at a time when a temperature is increased.

### INCORPORATION BY REFERENCE

The disclosure of Japanese Patent Application No. 2018-154715 filed on Aug. 21, 2018 including the specification, drawings and abstract is incorporated herein by reference in its entirety.

### BACKGROUND

### 1. Technical Field

The disclosure relates to a hot runner device.

### 2. Description of Related Art

In injection molding, molten resin is poured into a mold through a resin passage. Accordingly, at the time when a resin molded product is taken out of the mold, a runner is formed by the molten resin hardening in the resin passage. Therefore, steps of crushing and reusing the runner are required. In order to eliminate these steps, there has been known, in the related art, a hot runner device configured such that a fluid state of molten resin in a resin passage is maintained by a heater or the like, so that only a resin molded product can be taken out.

A general device as the hot runner device includes a fixed die for forming a cavity with a movable die, a hot runner block fixed to the fixed die, and a valve gate fixed to the fixed die such that its distal end portion faces toward the cavity, and the general device is configured such that molten resin is filled into the cavity from the valve gate through a resin passage in the hot runner block.

The hot runner device is often configured such that the hot runner block in which the resin passage is formed is formed as an integrated product (a single block), so that a seam or the like is not formed in order to restrain resin leakage. Further, the hot runner device is often configured such that the valve gate is opened and closed by causing a valve pin to reciprocate by means of a cylinder fixed to the hot runner block above the valve gate. More specifically, in a case where the molten resin is not supplied to the cavity, the valve pin is inserted into the distal end portion of the valve gate, so as to close the valve gate. In the meantime, in a case where the molten resin is supplied to the cavity, the valve pin is pulled out of the distal end portion of the valve gate, so as to open the valve gate.

In a case where a relatively large resin molded product such as a bumper of a vehicle is formed by injection molding, the hot runner block also tends to upsize along with upsizing of the fixed die. Further, the temperature of the hot runner block is increased from a normal temperature to about 200° C. so that the molten resin passes through the resin passage. In the meantime, the fixed die reaches only about 50° C. because a coolant flows so as to cool down the molten resin. Therefore, in a case of using a relatively large hot runner block formed as an integrated product, a thermal expansion difference that cannot be overlooked occurs between the hot runner block and the fixed die. Besides, a base end-side (the hot runner block-side) of the valve pin may deviate from a distal end-side (the fixed die-side), so that the valve pin may slide diagonally relative to the valve gate, and this may cause deformation or breakage of the valve pin.

For example, Japanese Unexamined Patent Application Publication No. 2012-061839 (JP 2012-061839 A) discloses a hot runner injection mold device including: a retainer having a receiving hole by which a uniform distance is formed from the retainer to a connecting member connected to an upper part of a valve gate, and a first central guide face; and a center alignment mechanism constituted by a guide ring member having a second central guide face corresponding to the first central guide face so that the center of the valve gate is aligned, and a central supporting surface that maintains the valve gate in a center aligned state.

### SUMMARY

In JP 2012-061839 A, a deformation caused by thermal expansion of a hot runner block is absorbed between the connecting member and the retainer, so that the deformation is not transmitted to the valve gate, and thus, a curvature deformation of the valve gate can be prevented. However, since a relatively large hot runner block is used, the following problem occurs.

A large hot runner block has such an advantage that resin leakage is restrained. However, the large hot runner block is manufactured by machining iron that is cut largely. Therefore, the large hot runner block has a poor yield, requires a large material cost, and requires a large-scale process machine. This causes a problem that a manufacturing cost increases.

Further, in the large hot runner block, the number of cartridge heaters for heating molten resin increases, and this causes a problem that a component cost and a manufacturing cost increase. Further, in the large hot runner block, its heat capacity is large, so a heating-up period is long, thereby causing such a problem that a power consumption is large.

The disclosure relates to a hot runner device and provides a technique to restrain an increase in equipment cost or the like and resin leakage and to restrain deformation and breakage of a valve pin that opens and closes a valve gate.

In the hot runner device of the disclosure, a hot runner block is constituted by a plurality of relatively small parts, and a thermal expansion difference between the hot runner block and a fixed die is absorbed by a hot runner pipe connecting the parts.

More specifically, a hot runner device according to one aspect of the disclosure includes a fixed die, a hot runner block, a valve gate, and a valve pin. The fixed die is configured to form a cavity together with a movable die. The hot runner block is fixed to the fixed die. The valve gate is fixed to the fixed die such that a distal end portion of the valve gate faces toward the cavity. The valve pin is configured to slide inside the valve gate so as to open and close the valve gate. Injected molten resin is filled into the cavity from the valve gate through the hot runner block.

The hot runner block includes a first block including a first resin passage into which the molten resin is injected, a second block including a second resin passage communicating with the valve gate, and a hot runner pipe through which the first resin passage communicates with the second resin passage. The hot runner pipe is disposed such that a first end of the hot runner pipe is fixed to one of the first and second blocks, and a second end of the hot runner pipe is distanced from the other one of the first and second blocks by a predetermined distance in a pipe axial direction during cold time. The predetermined distance is set to be smaller than an expansion amount of the hot runner pipe at a time when a temperature is increased.

In the configuration, the hot runner block is divided into the first block, the second block, and the hot runner pipe. That is, since the hot runner block is constituted by a plurality of relatively small parts, largely cut iron or the like is not required at the time of manufacturing a block. Accordingly, it is also possible to restrain the number of heaters or the like and to shorten a heating-up time or the like. Further, since the hot runner block is constituted by the relatively small parts, a thermal expansion amount of each part can be made relatively small.

Further, since the hot runner pipe through which the first resin passage communicates with the second resin passage is disposed such that the second end is distanced from the other one of the first and second blocks by the predetermined distance during the cold time, the hot runner pipe is allowed to extend within the predetermined distance. This makes it possible to absorb a thermal expansion difference between the hot runner block and the fixed die. This restrains a deviation between a base end-side (a hot runner block-side) of the valve pin and a distal end-side (a fixed die-side) of the valve pin, thereby making it possible to restrain the valve pin from sliding diagonally relative to the valve gate. Accordingly, it is possible to restrain deformation and breakage of the valve pin and to achieve a long life of the valve pin.

Besides, the predetermined distance between the other one of the first and second blocks and the hot runner pipe is set to be smaller than an expansion amount of the hot runner pipe at the time when the temperature is increased. Hereby, when molten resin at a high temperature starts flowing, the second end of the hot runner pipe thermally expanding can firmly contact the other one of the first and second blocks, thereby making it possible to restrain leakage of the molten resin.

As described above, with the configuration, it is possible to restrain an increase in equipment cost or the like and resin leakage and to restrain deformation and breakage of the valve pin.

The opening and closing of the valve gate is often performed by inserting the valve pin into the distal end portion of the valve gate and pulling out the valve pin from the distal end portion of the valve gate by driving, by a cylinder, the valve pin sliding inside the valve gate. In a relatively large hot runner block, a thermal expansion difference that exceeds an allowable range occurs between the hot runner block and the fixed die. Accordingly, the cylinder is fixed to a position corresponding to the valve gate on the hot runner block in general. However, in such a configuration, when a temperature increase state of the hot runner block continues for a long period, a device inside the cylinder might be damaged by a temperature increase of the cylinder due to heat transfer. On that account, generally, the cylinder is fixed to the hot runner block through a heat insulating material, but this causes such a problem that an equipment cost increases.

The hot runner device may further include a cylinder configured to drive the valve pin. The cylinder may be fixed to the fixed die so as to be placed above the second block placed on the valve gate.

In this configuration, the cylinder is provided above the valve gate, and hereby, the valve pin sliding inside the valve gate can be driven by the cylinder with a simple configuration. Besides, the cylinder is directly fixed to the fixed die so as to be placed above the second block, so that it is not necessary to provide a fixed portion for the cylinder on the second block, thereby making it possible to downsize the second block. As described above, since the cylinder is fixed to the fixed die having a relatively low temperature, the device inside the cylinder is unlikely to be damaged by the temperature increase of the cylinder due to heat transfer. Therefore, a heat insulating material is not required, thereby making it possible to restrain an increase in equipment cost.

In the hot runner device, the other one of the first and second blocks may be provided with a connecting hole portion having a circular section, the connecting hole portion extending in the pipe axial direction and communicating with the resin passage provided in the other one of the first and second blocks. The second end of the hot runner pipe may be inserted into the connecting hole portion in a slidable manner such that a distal surface of the second end is distanced from a bottom surface of the connecting hole portion by the predetermined distance in the pipe axial direction during the cold time. A first sealing member may be provided on the distal surface of the second end so as to fill a gap between the distal surface of the second end and the bottom surface of the connecting hole portion, and a second sealing member may be provided over a whole circumference of an outer peripheral surface of the second end so as to fill a gap between the outer peripheral surface of the second end and an inner peripheral surface of the connecting hole portion.

With this configuration, the second end of the hot runner pipe is slidably inserted into the connecting hole portion with an allowance (the predetermined distance). Accordingly, it is possible to easily achieve a state where the hot runner pipe is disposed such that the second end of the hot runner pipe is distanced from the other one of the first and second blocks by the predetermined distance in the pipe axial direction.

During the temperature increase during which molten resin starts flowing (in a state where there is a gap between a bottom portion of the connecting hole portion and the distal surface of the hot runner pipe), the first sealing member provided on the distal surface of the hot runner pipe fills the gap between the distal surface of the hot runner pipe and the bottom surface of the connecting hole portion (the first sealing member makes contact with the bottom surface), thereby making it possible to restrain leakage of the molten resin (a first sealing action). Further, after the temperature increase, the distal surface of the hot runner pipe thermally expanding contacts the bottom surface of the connecting hole portion. Accordingly, a sealing effect is caused by contact pressure, thereby making it possible to surely restrain leakage of the molten resin (a second sealing action). Further, the second sealing member is provided over the whole circumference of the outer peripheral surface of the second end of the hot runner pipe, and therefore, even if the resin leaks from between the distal surface of the hot runner pipe and the bottom surface of the connecting hole portion, the second sealing member fills the gap between the outer peripheral surface of the second end and the inner peripheral surface of the connecting hole portion (the second sealing member makes contact with the inner peripheral surface). Therefore, it is possible to more surely restrain leakage of the molten resin to the outside (a third sealing action). Thus, with the hot runner device of one aspect of the disclosure, by employing a three-step sealing structure, the resin leakage can be prevented surely.

In the meantime, in a case of a hot runner block as an integrated product, a resin pressure caused when the molten resin flows through the resin passage can be received by the rigid hot runner block itself. However, like the disclosure, in a case where the hot runner block is divided into the first block and the second block, each of the first and second blocks receives a resin pressure. Therefore, in a case where the first and second blocks are fixed to the fixed die via bolts, resin pressures cannot be received depending on the bolt, and the movements of the first and second blocks may not be able to be restrained.

In view of this, the hot runner device may further include resin pressure receiver blocks configured to respectively support parts of the first and second blocks, the parts being respectively located on sides opposite from connecting portions of the first and second blocks, the connecting portions being connected with the hot runner pipe. The resin pressure receiver blocks may be at least partially embedded in recessed portions formed in the fixed die.

In this configuration, the resin pressure receiver blocks are at least partially embedded in the recessed portions formed in the fixed die. That is, the resin pressure receiver blocks are attached to the fixed die in a fitted manner (the resin pressure receiver blocks are fitted in the fixed die), so that resin pressures can be firmly received by the resin pressure receiver blocks as compared with a bolt or the like.

The resin pressure caused when the molten resin flows through the resin passage is applied to each outer side of the hot runner pipe in its axial direction. With this configuration, respective parts of the first and second blocks on the sides opposite from connecting portions of the first and second blocks with the hot runner pipe are supported by respective resin pressure receiver blocks. This makes it possible to surely restrain the movements of the first and second blocks.

As described above, with the hot runner device according to one aspect of the disclosure, it is possible to restrain an increase in equipment cost or the like and resin leakage and to restrain deformation and breakage of the valve pin that opens and closes the valve gate.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view schematically illustrating a hot runner device according to an embodiment of the disclosure;

FIG. 2 is a perspective view schematically illustrating a valve gate unit;

FIG. 3 is a conception diagram to schematically describe a thermal expansion absorption mechanism;

FIG. 4A is an enlarged view illustrating a connection structure between a first block and a hot runner pipe during cold time;

FIG. 4B is an enlarged view illustrating the connection structure between the first block and the hot runner pipe after the temperature increases;

FIG. 5 is a view to schematically describe a resin pressure receiver block;

FIG. 6 is a view schematically illustrating an essential part of a hot runner device according to a modification;

FIG. 7 is a view schematically illustrating a hot runner device in the related art; and

FIG. 8 is a view schematically illustrating the hot runner device in the related art.

### DETAILED DESCRIPTION OF EMBODIMENTS

With reference to the drawings, the following describes an embodiment to carry out the disclosure.

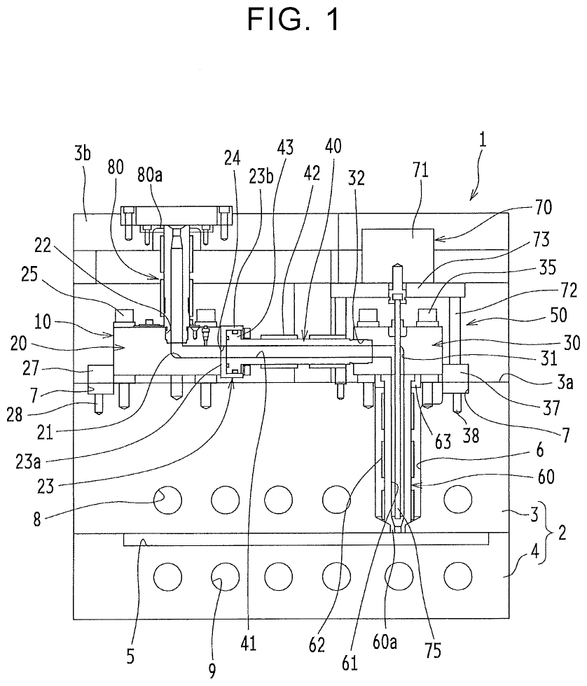

FIG. 1 is a view schematically illustrating a hot runner device 1 according to the present embodiment. The hot runner device 1 forms, for example, a relatively large resin molded product such as a bumper of a vehicle by injection molding. As illustrated in FIG. 1, the hot runner device 1 includes an injection molding die 2, a hot runner block 10, a valve gate unit 50, and a hot runner nozzle 80. Note that, in the following description, the right-left direction in FIG. 1 is referred to as a mold longitudinal direction, the right side is referred to as a first side in the mold longitudinal direction, and the left side is referred to as a second side in the mold longitudinal direction, for convenience.

The injection molding die 2 includes a fixed die 3 and a movable die 4 displaceable relative to the fixed die 3 in the up-down direction. At the time of mold clamping, the movable die 4 moves upward to approach the fixed die 3 and forms a cavity 5 together with the fixed die 3. By injecting resin melted at a high temperature of about 200° C. into the cavity 5 and cooling the resin thus melted, a desired resin molded product corresponding to the shape of the cavity 5 is molded. At the time of mold opening, the movable die 4 moves downward to be distanced from the fixed die 3, and hereby, the resin molded product can be taken out of the injection molding die 2.

Further, the fixed die 3 has a mounting hole 6 for a valve gate bush 60 (corresponding to a valve gate in the disclosure). The mounting hole 6 extends downward from a top face 3a of the fixed die 3 and reaches the cavity 5. Further, recessed portions 7 recessed downward from the top face 3a are formed in the opposite end portions of the fixed die 3 in the mold longitudinal direction such that resin pressure receiver blocks 27, 37 (described below) are to be provided in the recessed portions 7. Note that a reference sign 8 and a reference sign 9 in FIG. 1 are formed in the fixed die 3 and the movable die 4, respectively, and the reference sign 8 and the reference sign 9 are coolant holes through which a coolant flows to cool down and solidify molten resin filled in the cavity 5.

The hot runner block 10 includes a first block 20 fixed to the top face 3a of the fixed die 3 with a bolt 25, a second block 30 disposed on the first side in the mold longitudinal direction so as to be distanced from the first block 20, the second block 30 being fixed to the top face 3a of the fixed die 3 with a bolt 35, and a hot runner pipe 40 having a first end screwed into the second block 30 so that the hot runner pipe 40 is fixed, and thus, the hot runner block 10 is completely fixed to the fixed die 3. As such, in the present embodiment, the hot runner block 10 is divided into relatively small parts (the first block 20, the second block 30, and the hot runner pipe 40).

The first block 20 has a substantially rectangular-solid shape. A resin inlet 22 recessed downward is provided on the top face of the first block 20. Inside the first block 20, a first resin passage 21 is provided such that the first resin passage 21 extends downward from a bottom portion of the resin inlet 22 and then bends at the right angle to extend toward the first side in the mold longitudinal direction. Further, a cartridge heater (not shown) is provided in the first block 20. Due to heating by the cartridge heater, a fluid state of molten resin flowing through the first resin passage 21 is maintained.

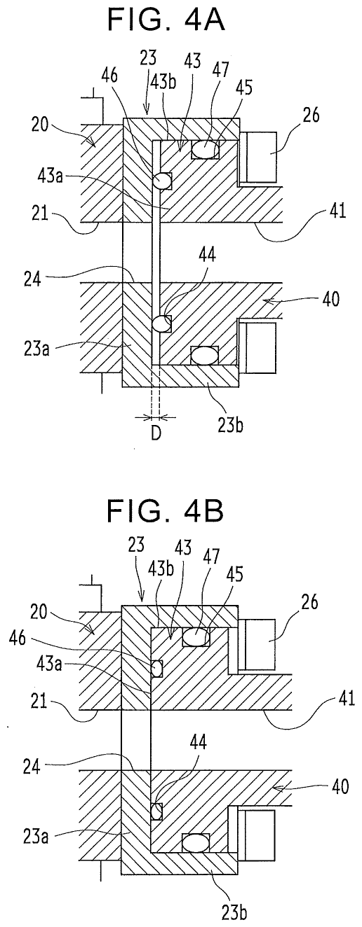

Further, a surface of the first block 20 on the first side in the mold longitudinal direction is provided with a bottomed cylindrical connecting portion (connecting hole portion) 23 including a bottom portion 23a and a cylindrical portion 23b. A through-hole 24 coaxial with the first resin passage 21 and having the same diameter as the first resin passage 21 is provided in the bottom portion 23a attached to the surface of the first block 20 on the first side in the mold longitudinal direction. Hereby, the cylindrical portion 23b of the connecting portion 23 communicates with the first resin passage 21. Note that the connecting portion 23 is fixed to the first block 20 with a fixing member 26 (see FIGS. 4A, 4B).

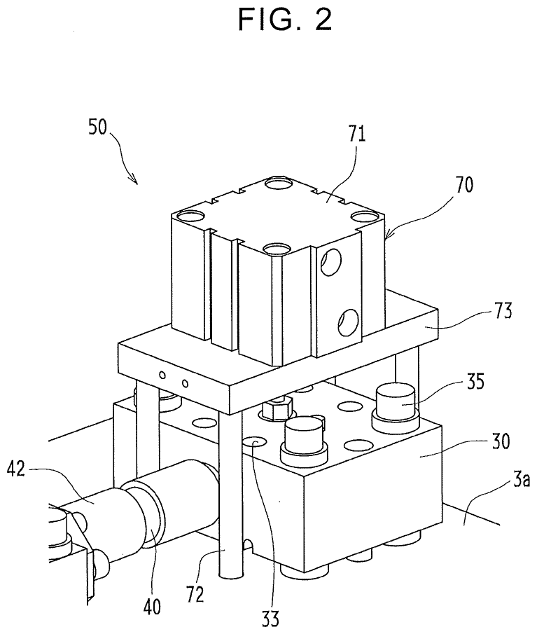

The second block 30 has a substantially rectangular-solid shape. A screw thread hole 32 recessed toward the first side in the mold longitudinal direction is provided on a surface of the second block 30 on the second side in the mold longitudinal direction. Inside the second block 30, a second resin passage 31 is provided such that the second resin passage 31 extends from a bottom portion of the screw thread hole 32 toward the first side in the mold longitudinal direction and then bends at the right angle to extend downward. Further, in the second block 30, a cartridge heater is inserted into a hole portion 33 (see FIG. 2). Due to heating by the cartridge heater, a fluid state of molten resin flowing through the second resin passage 31 is maintained.

A resin passage 41 inside the hot runner pipe 40 is set to have the same diameter as the first resin passage 21 and the second resin passage 31. An outer peripheral surface of an end of the hot runner pipe 40 on the first side in the mold longitudinal direction is threaded. In the meantime, a toric flange portion 43 is provided on an end of the hot runner pipe 40 on the second side in the mold longitudinal direction. The outside diameter of the flange portion 43 is set to be slightly smaller than the inside diameter of the cylindrical portion 23b of the connecting portion 23 so that the flange portion 43 is slidable inside the cylindrical portion 23b.

The length of the hot runner pipe 40 is set to be smaller than a distance between the first block 20 and the second block 30 in the mold longitudinal direction. More specifically, the length of the hot runner pipe 40 is set to be smaller by a predetermined distance D than a distance between the bottom portion 23a attached to the surface of the first block 20 on the first side in the mold longitudinal direction and the bottom portion of the screw thread hole 32 formed on the surface of the second block 30 on the second side in the mold longitudinal direction. The predetermined distance D is set to be smaller than an expansion amount of the hot runner pipe 40 at the time when the temperature is increased to about 200° C. after cold time. Note that the “cold time” indicates a state at a normal temperature (a state where injection molding is not performed).

The outer peripheral surface of the end of the hot runner pipe 40 on the first side in the mold longitudinal direction is threaded, and the end of the hot runner pipe 40 on the first side in the mold longitudinal direction is screwed into the screw thread hole 32 of the second block 30. Hereby, the hot runner pipe 40 is fixed to the fixed die 3 via the second block 30. Further, the toric flange portion 43 of the hot runner pipe 40 is inserted into the cylindrical portion 23b of the connecting portion 23 in the first block 20 so that a distal surface 43a of the flange portion 43 is distanced from the bottom portion 23a by the predetermined distance D during the cold time. That is, the hot runner pipe 40 is disposed such that its first end is fixed to the second block 30, and its second end is distanced from the first block 20 by the predetermined distance D in the pipe axial direction during the cold time. In other words, the first end of the hot runner pipe 40 is a fixed end, and the second end of the hot runner pipe 40 is a free end that is displaceable by the predetermined distance D in the mold longitudinal direction. The hot runner pipe 40 is supported by the first block 20 and the second block 30 in a state like a double-supported beam.

By disposing the hot runner pipe 40 as described above, the first resin passage 21 communicates with the second resin passage 31 via the resin passage 41 of the hot runner pipe 40. Further, a band heater 42 is wound around the outer peripheral surface of the hot runner pipe 40. Due to heating by the band heater 42, a fluid state of molten resin flowing through the hot runner pipe 40 is maintained. By employing a pipe shape having a uniform wall thickness as such, force or heat can be transmitted uniformly.

FIG. 2 is a perspective view schematically illustrating a valve gate unit 50. The valve gate unit 50 includes the valve gate bush 60, the second block 30, and a cylinder device 70. In the present embodiment, the second block 30 forms a part of the hot runner block 10 and also forms a part of the valve gate unit 50.

The valve gate bush 60 is inserted into the mounting hole 6 of the fixed die 3 so that a distal end portion 60a formed to be tapered downward faces toward the cavity 5. The distal end portion 60a of the valve gate bush 60 is inserted into a lower end portion of the mounting hole 6, and its base end is fitted to a collar 63 fixed to the fixed die 3 with the bolt 35. Hereby, the valve gate bush 60 is fixed to the fixed die 3. An upper end portion of the valve gate bush 60 contacts a lower face of the second block 30. Hereby, a resin passage 61 of the valve gate bush 60 communicates with the second resin passage 31. A band heater 62 is wound around an outer peripheral surface of the valve gate bush 60. Due to heating by the band heater 62, a fluid state of molten resin flowing through the resin passage 61 of the valve gate bush 60 is maintained.

The cylinder device 70 includes a valve pin 75 configured to open and close the valve gate bush 60, an air cylinder 71 configured to drive the valve pin 75, and four columnar stilts 72 and a fixing plate 73 configured to support the air cylinder 71 to the fixed die 3. Note that, in the present embodiment, an air-type drive source is employed as a drive source for the valve pin 75. Further, various drive sources including a hydraulic drive source and an electric drive source can be used.

The valve pin 75 is inserted into the resin passage 61 of the valve gate bush 60. The valve pin 75 is driven to advance and retreat in the up-down direction by the air cylinder 71 placed above the valve gate bush 60. Hereby, the valve pin 75 slides inside the valve gate bush 60.

The air cylinder 71 is provided above the second block 30 placed on the valve gate bush 60. More specifically, as illustrated in FIGS. 1 and 2, two columnar stilts 72 on the first side of the second block 30 in the mold longitudinal direction and two columnar stilts 72 on the second side thereof are fixed to the fixed die 3, and the fixing plate 73 is attached to upper end portions of the columnar stilts 72 so that the air cylinder 71 is placed above the second block 30. The air cylinder 71 is provided on the fixing plate 73. That is, the air cylinder 71 is fixed to the fixed die 3 via the columnar stilts 72 and the fixing plate 73 so as to be placed above the second block 30 placed on the valve gate bush 60.

The air cylinder 71 drives the valve pin 75 so as to open and close the valve gate bush 60. More specifically, in a case where molten resin is not supplied to the cavity 5, the air cylinder 71 inserts the valve pin 75 into the distal end portion 60a of the valve gate bush 60. Hereby, the valve gate bush 60 is closed. In the meantime, in a case where molten resin is supplied to the cavity 5, the air cylinder 71 pulls out the valve pin 75 from the distal end portion 60a of the valve gate bush 60. Hereby, the valve gate bush 60 is opened. Note that whether the valve gate bush 60 is opened or closed is checked by an automatic switch (not shown) provided inside the air cylinder 71 so as to check an operation end of the cylinder.

The hot runner nozzle 80 determines an axial position by a nozzle bush 80a attached to a fixed attachment plate 3b of the fixed die 3. Further, a distal end portion of the hot runner nozzle 80 is fitted in the resin inlet 22 of the first block 20. The hot runner nozzle 80 makes contact with an injection molding machine (not shown). The hot runner nozzle 80 is configured to cause resin to flow into a mold or the hot runner device 1. More specifically, the resin is heated up and receives a kneading compression action along with rotation of a screw or the like in the injection molding machine, and thus, the resin is brought to a molten state and is injected from the injection molding machine. Then, the hot runner nozzle 80 causes the resin in the molten state to flow into the mold or the hot runner device 1.

In the hot runner device 1 of the present embodiment configured as described above, molten resin is filled into the cavity 5 from the valve gate bush 60 through the hot runner block 10. More specifically, molten resin injected from the hot runner nozzle 80 passes through the first resin passage 21 of the first block 20, the resin passage 41 of the hot runner pipe 40, and the second resin passage 31 of the second block 30 sequentially in this order and reaches the resin passage 61 of the valve gate bush 60. In a case where the valve gate bush 60 is opened, the molten resin is filled into the cavity 5 from the resin passage 61 of the valve gate bush 60. After the molten resin is filled, the valve pin 75 is inserted into the distal end portion 60a of the valve gate bush 60, so that the valve gate bush 60 is closed. The molten resin filled into the cavity 5 is cooled and solidified by the coolant flowing through the coolant holes 8, 9, and after mold opening, a resin molded product is taken out from the injection molding die 2. In the meantime, respective fluid states of the molten resin in the first resin passage 21, the molten resin in the resin passage 41, the molten resin in the second resin passage 31, and the molten resin in the resin passage 61 are maintained by heating by the cartridge heater and the band heaters 42, 62. Hereby, no runner is formed, so that steps of crushing and reusing the runner are not required.

Next will be described an advantage of the hot runner device 1. First, a hot runner device in the related art will be described briefly for easy understanding of the present embodiment.

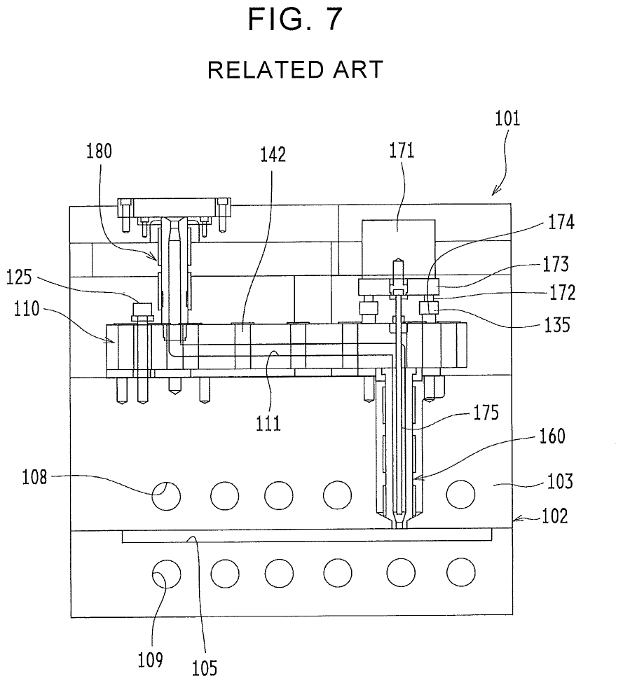

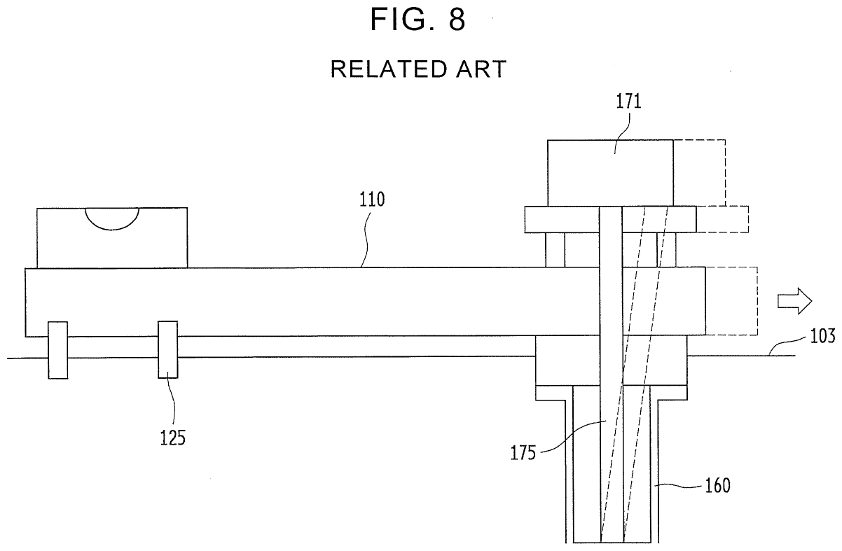

FIGS. 7, 8 are views schematically illustrating a hot runner device 101 in the related art. In the hot runner device 101 in the related art, molten resin injected from a hot runner nozzle 180 is filled into a cavity 105 of an injection molding die 102 from a valve gate bush 160 through a hot runner block 110, similarly to the present embodiment. Further, in the hot runner device 101 in the related art, the valve gate bush 160 is also opened and closed by a valve pin 175 configured to be advanced and retreated by an air cylinder 171, similarly to the present embodiment.

In the hot runner device 101 in the related art, the hot runner block 110 is manufactured as an integrated product (a single block) as illustrated in FIG. 7. Besides, in a case where a relatively large resin molded product such as a bumper of a vehicle is formed by injection molding, the hot runner block 110 as the integrated product also tends to upsize. Further, in the relatively large hot runner block 110, a thermal expansion difference that exceeds an allowable range occurs between the hot runner block 110 and the fixed die 103. Therefore, in the hot runner device 101 in the related art, the air cylinder 171 is fixed to the hot runner block 110 in general, as illustrated in FIG. 7.

The large hot runner block 110 as the integrated product is manufactured by performing machining on largely cut iron, for example. Therefore, the hot runner block 110 has a poor yield, requires a large material cost, and requires a large-scale process machine. This causes a problem that a manufacturing cost increases. Further, in the large hot runner block 110, the number of cartridge heaters 142 for heating molten resin increases, and this causes a problem that a component cost and a manufacturing cost increase. Further, in the large hot runner block 110, its heat capacity is large, so a heating-up period is long, thereby causing such a problem that a power consumption is large.

Further, the temperature of the hot runner block 110 is increased from a normal temperature to about 200° C. in order that molten resin passes through the resin passage 111. In the meantime, the fixed die 103 reaches only about 50° C. because a coolant flows through coolant holes 108, 109 so as to cool down the molten resin. Besides, in the hot runner device 101 in the related art, the hot runner nozzle 180 side of the hot runner block 110 is completely fixed to a fixed die 103 with a bolt 125. In the meantime, the valve gate bush 160 side of the hot runner block 110 is fixed to the fixed die 103 with a bolt 135 inserted into an elongated hole (not shown) formed in the hot runner block 110. Therefore, the hot runner device 101 in the related art has such a structure that, when thermal expansion occurs in the hot runner block 110, a slip occurs between a lower face of the hot runner block 110 and an upper end of the valve gate bush 160. Therefore, in a case of using the relatively large hot runner block 110 formed as the integrated product and the fixed die 103, a thermal expansion difference that cannot be overlooked occurs therebetween. Further, as illustrated in FIG. 8, a base end-side (the hot runner block 110 side) of the valve pin 175 may deviate from a distal end-side (the fixed die 103 side) thereof, so that the valve pin 175 slides diagonally relative to the valve gate bush 160, and this may cause deformation or breakage of the valve pin 175.

Further, in the configuration in which the air cylinder 171 is fixed to the hot runner block 110, when a temperature increase state of the hot runner block 110 continues for a long period, an automatic switch might be damaged by a temperature increase of the air cylinder 171 due to heat transfer. Therefore, generally, the air cylinder 171 is fixed to the hot runner block 110 via a heat insulating material 174 (stainless steel, bakelite, or the like) in addition to columnar stilts 172 and a fixing plate 173. However, this causes such a problem that an equipment cost increases.

In order to deal with those problems, the hot runner device 1 of the present embodiment employs the following configurations (1) to (5).

In the present embodiment, (1) the divided structure of the hot runner block is employed. More specifically, the hot runner block 10 is divided into the first block 20, the second block 30, and the hot runner pipe 40 as described above. In other words, since the hot runner block 10 is constituted by a plurality of relatively small parts, largely cut iron or the like is not required at the time of manufacturing the hot runner block 10, thereby making it possible to improve a yield. Furthermore, the first block 20, the second block 30, and the hot runner pipe 40 are relatively small, so that it is possible to achieve downsizing of a process machine and shortening of a manufacturing process.

Besides, since each part is relatively small, it is possible to restrain the number of cartridge heaters and the number of band heaters 42, and it is also possible to shorten a heating-up time or the like by restraining a heat capacity. This makes it possible to restrain power consumption or the like. Besides, by employing a pipe shape for the hot runner pipe 40, a volume can be minimized. Further, since the band heater 42 can be used, it is possible to restrain an increase in component cost and assembling cost.

Further, since the hot runner block 10 is constituted by the relatively small parts and the hot runner pipe 40 is disposed to be distanced from the first block 20 by the predetermined distance D, the parts can be disassembled. Therefore, in a case where a given part is damaged, it is possible to improve disassembly workability and assembly workability. Further, since the hot runner block 10 is constituted by the relatively small parts, a thermal expansion amount of each part can be made relatively small.

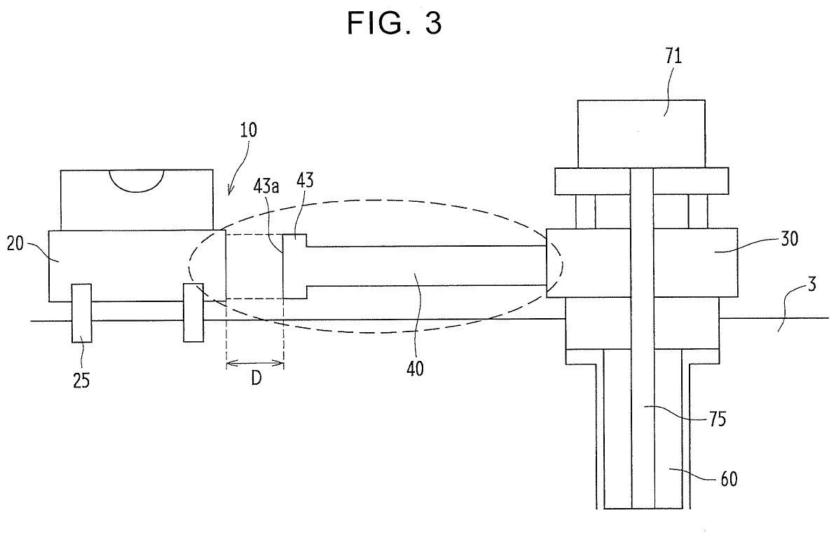

In the present embodiment, (2) the thermal expansion absorption structure is employed. More specifically, FIG. 3 is a conception diagram to schematically describe a thermal expansion absorption mechanism. As described above, the first end of the hot runner pipe 40 through which the first resin passage 21 communicates with the second resin passage 31 is fixed to the second block 30, and at a normal temperature, the distal surface 43a of the second end of the hot runner pipe 40 is disposed to be distanced from the first block 20 by the predetermined distance D in the pipe axial direction (the mold longitudinal direction). As can be seen from the comparison between FIG. 3 and FIG. 8, since the distal surface 43a of the hot runner pipe 40 is disposed to be distanced from the first block 20 by the predetermined distance D in the pipe axial direction, the hot runner pipe 40 is allowed to extend within the predetermined distance D. This makes it possible to absorb a thermal expansion difference between the hot runner block 10 and the fixed die 3. Further, this restrains the deviation between the base end-side (the hot runner block 10 side) of the valve pin 75 and the distal end-side (the fixed die 3 side) of the valve pin 75, thereby making it possible to restrain such a situation that the valve pin 75 diagonally slides relative to the valve gate bush 60. Accordingly, it is possible to cause the valve pin 75 to slide in a straight manner relative to the valve gate bush 60. As a result, it is possible to restrain deformation and breakage of the valve pin 75 and to achieve a long life of the valve pin 75.

The predetermined distance D is set to be smaller than the expansion amount of the hot runner pipe 40 at the time when the temperature is increased to about 200° C. after the cold time. Therefore, when molten resin starts flowing, the distal surface 43a of the hot runner pipe 40 thermally expanding can firmly contact the first block 20 (more precisely, the bottom portion 23a of the connecting portion 23). This makes it possible to restrain leakage of the molten resin.

In the present embodiment, (3) the sealing structure of connecting portion is employed. More specifically, FIGS. 4A and 4B are enlarged views illustrating a connection structure between the first block 20 and the hot runner pipe 40. FIG. 4A illustrates a state during the cold time. FIG. 4B illustrates a state after the temperature increases. As illustrated in FIG. 4A, a toric recessed portion 44 is formed around the resin passage 41 on the distal surface 43a of the flange portion 43 of the hot runner pipe 40. An annular first heat-resistant O-ring (a first sealing member) 46 is fitted in the toric recessed portion 44 such that the first heat-resistant O-ring 46 projects from the distal surface 43a. In the meantime, a groove 45 is formed over a whole circumference of an outer peripheral surface 43b of the flange portion 43 of the hot runner pipe 40. An annular second heat-resistant O-ring (a second sealing member) 47 is fitted in the groove 45.

In the present embodiment, as illustrated in FIG. 4A, the flange portion 43 of the hot runner pipe 40 is inserted into the cylindrical portion 23b of the connecting portion 23 in a slidable manner such that the distal surface 43a is distanced from the bottom portion 23a of the connecting portion 23 by the predetermined distance D in the pipe axial direction during the cold time. In this state, the bottom portion 23a of the connecting portion 23 makes contact with the first heat-resistant O-ring 46.

With such a configuration, during the temperature increase during which molten resin starts flowing (in a state where there is a gap between the bottom portion 23a of the connecting portion 23 and the distal surface 43a of the hot runner pipe 40), the first heat-resistant O-ring 46 fills the gap from the bottom portion 23a of the connecting portion 23 (the first heat-resistant O-ring 46 makes contact with the bottom portion 23a). This makes it possible to restrain leakage of the molten resin (a first sealing action).

Further, after the temperature increase, the distal surface 43a of the flange portion 43 of the hot runner pipe 40 thermally expanding contacts the bottom portion 23a of the connecting portion 23, as illustrated in FIG. 4B. Accordingly, a sealing effect is caused by contact pressure. This makes it possible to surely restrain leakage of the molten resin (a second sealing action).

Further, the outside diameter of the flange portion 43 of the hot runner pipe 40 is set to be slightly smaller than the inside diameter of the cylindrical portion 23b of the connecting portion 23. Therefore, the outer peripheral surface 43b of the flange portion 43 and an inner peripheral surface of the cylindrical portion 23b are formed as tolerance surfaces with a slight gap therebetween, and thus, even if the resin leaks from between the distal surface 43a of the flange portion 43 and the bottom portion 23a of the connecting portion 23, the resin is hard to pass through between the outer peripheral surface 43b of the flange portion 43 and the inner peripheral surface of the cylindrical portion 23b. Besides, the second heat-resistant O-ring 47 is provided over the whole circumference of the outer peripheral surface 43b of the flange portion 43. Accordingly, even if the resin passes through between the outer peripheral surface 43b of the flange portion 43 and the inner peripheral surface of the cylindrical portion 23b, the second heat-resistant O-ring 47 fills the gap from the inner peripheral surface of the cylindrical portion 23b (the second heat-resistant O-ring 47 makes contact with the inner peripheral surface of the cylindrical portion 23b). This makes it possible to more surely restrain leakage of the molten resin to the outside (a third sealing action).

As described above, in the hot runner device 1 of the present embodiment, by employing a three-step sealing structure, the resin leakage can be prevented surely.

In the present embodiment, (4) the fixing structure of air cylinder is employed. More specifically, the fixing plate 73 is attached to respective upper end portions of the columnar stilts 72 fixed to the fixed die 3 such that the air cylinder 71 is placed above the second block 30, and the air cylinder 71 is provided on the fixing plate 73. Hereby, the air cylinder 71 is fixed to the fixed die 3 via the columnar stilts 72 and the fixing plate 73. Since the air cylinder 71 is provided above the second block 30 placed on the valve gate bush 60, it is possible to cause the valve pin 75 to advance and retreat relative to the valve gate bush 60 by means of the air cylinder 71 with a simple configuration. Besides, when the air cylinder 71 is directly fixed to the fixed die 3 so as to be placed above the second block 30, it is not necessary to provide a fixed portion for the air cylinder 71 on the second block 30. This makes it possible to downsize the second block 30.

The temperature of the fixed die 3 increases only to about 50° C., and therefore, even if the temperature is increased for a long period, the temperature of the air cylinder 71 is hard to increase. Therefore, the automatic switch is unlikely to be damaged by the temperature increase of the air cylinder 71 due to heat transfer. Therefore, a heat insulating material is not required, thereby making it possible to restrain an increase in equipment cost and to achieve a long life of the automatic switch.

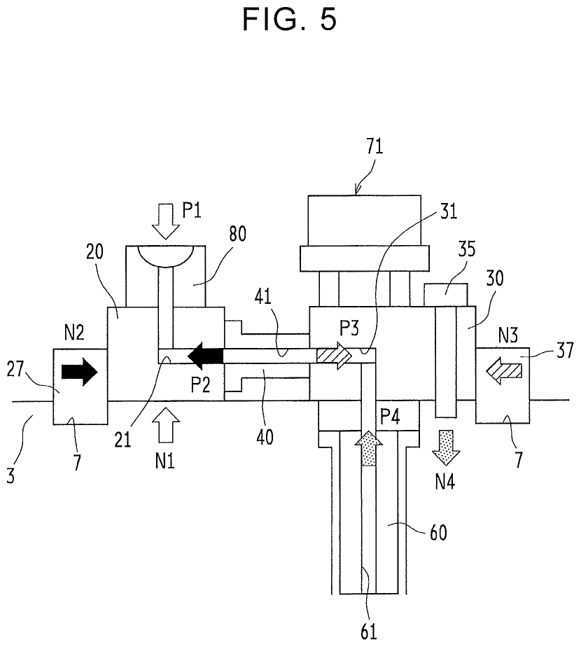

In the present embodiment, (5) the resin pressure receiver block is employed. More specifically, FIG. 5 is a view to schematically describe the resin pressure receiver blocks 27, 37. When the resin passage bends, a resin pressure occurs at the time of injection molding. In a case of the hot runner block 110 as the integrated product, a resin pressure caused when molten resin flows through the resin passage can be received by the rigid hot runner block 110 itself. On the other hand, like the disclosure, in a case where the hot runner block is divided into the first block 20 and the second block 30, each of the blocks receives a resin pressure. More specifically, as illustrated in FIG. 5, a downward resin pressure P1 and a resin pressure P2 directed toward the second side in the mold longitudinal direction are applied to the first block 20, and a resin pressure P3 directed toward the first side in the mold longitudinal direction and an upward resin pressure P4 are applied to the second block 30.

In terms of the downward resin pressure P1, the first block 20 is received by the fixed die 3, so that a reaction force N1 corresponding to the resin pressure P1 can be generated. Further, the axial-force of a bolt is relatively large. Also, the upward resin pressure P4 is received by the axial-force of the bolt 35 fixing the second block 30, so that a reaction force N4 corresponding to the resin pressure P4 can be generated. In the meantime, the shear strength of a bolt is relatively low, and therefore, it might be difficult to receive the resin pressure P2 and the resin pressure P3 by the shear forces of the bolts 25, 35 in some cases (the first block 20 and the second block 30 might move). When the first block 20 and the second block 30 move, resin leakage might occur.

In view of this, the hot runner device 1 of the present embodiment is provided with the resin pressure receiver blocks 27, 37 that respectively support parts of the first block 20 and the second block 30, the parts being respectively located on the sides opposite from connecting portions of the first block 20 and the second block 30, and the connecting portions being connected with the hot runner pipe 40. The resin pressure receiver blocks 27, 37 are fixed to the fixed die 3 with bolts 28, 38 as illustrated in FIG. 1, and, in addition to this, the resin pressure receiver blocks 27, 37 are partially embedded into the recessed portions 7 formed in the fixed die 3 as illustrated in FIG. 5.

As described above, the resin pressure receiver blocks 27, 37 are partially embedded into the recessed portions 7 formed in the fixed die 3 (that is, the resin pressure receiver blocks 27, 37 are attached to the fixed die 3 in a fitted manner), so that the resin pressure receiver blocks 27, 37 can firmly receive the resin pressure P2 and the resin pressure P3 in comparison with the bolts 25, 35, or the like.

Hereby, when the resin pressure P2 is received by the resin pressure receiver block 27 attached to the fixed die 3 in a fitted manner (i.e., the resin pressure receiver blocks 27 fitted in the fixed die 3), a reaction force N2 corresponding to the resin pressure P2 can be generated. Further, when the resin pressure P3 is received by the resin pressure receiver block 37 attached to the fixed die 3 in a fitted manner (i.e., the resin pressure receiver blocks 37 fitted in the fixed die 3), a reaction force N3 corresponding to the resin pressure P3 can be generated. Accordingly, the movements of the first block 20 and the second block 30 can be restrained.

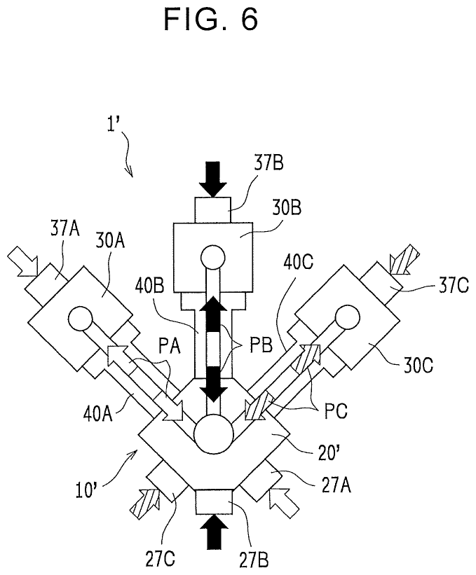

FIG. 6 is a view schematically illustrating an essential part of a hot runner device 1′ according to the modification. In the above embodiment, the hot runner block 10 is divided into the first block 20, the second block 30, and the hot runner pipe 40. However, in the present modification, a hot runner block 10′ is divided into one first block 20′, three second blocks 30A, 30B, 30C, and three hot runner pipes 40A, 40B, 40C. As compared to a case where molten resin is filled from one valve gate bush 60, when a plurality of second blocks 30A, 30B, 30C communicating with respective valve gate bushes 60 is provided, the cavity 5 can be filled with the molten resin without nonuniformity. Note that, in the present modification, the hot runner pipes 40A, 40B, 40C are fixed to the first block 20′, and their distal surfaces are disposed to be distanced from the second blocks 30A, 30B, 30C by a predetermined distance in their respective pipe axial directions during the cold time.

Even with the configuration, respective parts of the blocks on the sides opposite from their connecting portions with the hot runner pipes 40A, 40B, 40C are supported by the resin pressure receiver blocks. This makes it possible to restrain the movements of the blocks and to restrain resin leakage. More specifically, as illustrated in FIG. 6, resin pressure receiver blocks 27A, 37A fixed in a fitted manner are disposed so as to correspond to a resin pressure PA, resin pressure receiver blocks 27B, 37B fixed in a fitted manner are disposed so as to correspond to a resin pressure PB, and resin pressure receiver blocks 27C, 37C fixed in a fitted manner are disposed so as to correspond to a resin pressure PC. Hereby, the movements of the first block 20′ and the second blocks 30A, 30B, 30C can be restrained.

The disclosure is not limited to the above embodiments and can be carried out in other various forms without departing from a main feature of the disclosure.

In the above embodiment, the hot runner pipe 40 is fixed to the second block 30 and is disposed such that its distal surface 43a is distanced from the first block 20 by the predetermined distance D in the pipe axial direction during the cold time. However, the hot runner pipe 40 may be fixed to one of the first block 20 and the second block 30, and its distal surface 43a may be disposed to be distanced from the other one of the first block 20 and the second block 30 by the predetermined distance D in the pipe axial direction. Therefore, the hot runner pipe 40 may be fixed to the first block 20, and its distal surface 43a may be displaced to be distanced from the second block 30 by the predetermined distance D in the pipe axial direction.

Further, in the above embodiment, as the connecting hole portion into which the hot runner pipe 40 is inserted, the bottomed cylindrical connecting portion 23 is provided in the first block 20. However, the disclosure is not limited to this, a connecting hole portion may be formed by a recessed portion formed by denting a side face of the first block 20 to have a circular section.

Thus, the above embodiment is just an example in every respect and must not be interpreted restrictively. Further, modifications and alterations belonging to an equivalent range of Claims are all included in the disclosure.

With the hot runner device according to one aspect of the disclosure, it is possible to restrain an increase in equipment cost or the like and resin leakage and to restrain deformation and breakage of a valve pin that opens and closes a valve gate.

What is claimed is:

1. A hot runner device comprising:
a fixed die configured to form a cavity together with a movable die;
a hot runner block fixed to the fixed die;
a valve gate fixed to the fixed die such that a distal end portion of the valve gate faces toward the cavity; and
a valve pin configured to slide inside the valve gate so as to open and close the valve gate, wherein:
injected molten resin is filled into the cavity from the valve gate through the hot runner block;
the hot runner block includes a first block including a first resin passage into which the molten resin is injected, a second block including a second resin passage communicating with the valve gate, and a hot runner pipe through which the first resin passage communicates with the second resin passage; and
the hot runner pipe is disposed such that a first end of the hot runner pipe is fixed to one of the first and second blocks, and a second end of the hot runner pipe is distanced from the other one of the first and second blocks by a predetermined distance in a pipe axial direction during cold time, the predetermined distance being set to be smaller than an expansion amount of the hot runner pipe at a time when a temperature is increased.

2. The hot runner device according to claim 1, further comprising a cylinder configured to drive the valve pin, wherein the cylinder is fixed to the fixed die so as to be placed above the second block placed on the valve gate.

3. The hot runner device according to claim 1, wherein:
the other one of the first and second blocks is provided with a connecting hole portion having a circular section, the connecting hole portion extending in the pipe axial direction and communicating with the resin passage provided in the other one of the first and second blocks;
the second end of the hot runner pipe is inserted into the connecting hole portion in a slidable manner such that a distal surface of the second end is distanced from a bottom surface of the connecting hole portion by the predetermined distance in the pipe axial direction during the cold time; and
a first sealing member is provided on the distal surface of the second end so as to fill a gap between the distal surface of the second end and the bottom surface of the connecting hole portion, and a second sealing member is provided over a whole circumference of an outer peripheral surface of the second end so as to fill a gap between the outer peripheral surface of the second end and an inner peripheral surface of the connecting hole portion.

4. The hot runner device according to claim 1, further comprising resin pressure receiver blocks configured to respectively support parts of the first and second blocks, the parts being respectively located on sides opposite from connecting portions of the first and second blocks, and the connecting portions being connected with the hot runner pipe, wherein the resin pressure receiver blocks are at least partially embedded in recessed portions provided in the fixed die.
